(19) United States
(12) Patent Application Publication
(10) Pub. No.: US 2008/0304689 A1
(43) Pub. Date: Dec. 11, 2008

(54) Mount For an Acoustic Device

(76) Inventor: Nicholas E. Curzon, New South Wales (AU)

Correspondence Address: CONNOLLY BOVE LODGE & HUTZ LLP, 1875 EYE STREET, N.W., SUITE 1100, WASHINGTON, DC, 20006, US

(21) Appl. No.: 11/719,036

(22) PCT Filed: Oct. 19, 2005
(86) PCT No.: PCT/AU2005/001620

§ 371 Date: Oct. 19, 2007

(30) Foreign Application Priority Data
Nov. 11, 2004 (AU) 2004906452
Mar. 8, 2005 (AU) 2005901080

(51) Int. Cl. H04R 25/00; H04R 1/10

(52) U.S. Cl. 381/374; 381/380; 381/74

(57) ABSTRACT

A headset (10, 20, 30, 40) able to function with earplugs (15) or ear phones (25) is disclosed. The headset includes a pair of protrusions (16) able to be grasped by a single hand to expand the free ends (14) of the arms (11) which carry the earplugs or ear phones. Alternatively, one arm includes a hinge (31) and protrusion (36) which are able to be single handedly grasped to expand the free ends. In this way single handed removal of the headset is able to be achieved.

### FIELD OF THE INVENTION

The present invention relates to acoustic devices in the form of headsets for either earplugs or earphones.

### BACKGROUND ART

It is well known that prolonged exposure to excessive noise levels causes permanent damage to human hearing and this is a frequent cause of industrial deafness. The risk of sustaining damage is extremely high in many industries including the building industry where many items of equipment such as nail guns, electric saws, jackhammers and RAMSET guns are frequently used. For this reason, industrial workers are encouraged, and frequently obliged, to wear earplugs. Because of the need to communicate with other individuals, it is necessary for such earplugs to be put in, and pulled out, frequently. Particular putting in the earplugs is a two-handed operation which necessitates the industrial worker putting down a tool or similar equipment held in one hand, in order to free both hands for the ear plug insertion operation.

Similarly, many persons use a headset in order to listen to a mobile telephone conversation, or acoustic entertainment devices such as those sold under the trade marks WALKMAN or iPOD. Again, if such a person is holding a briefcase or shopping bag in one hand, it is difficult to remove the earphones of the headset with a single hand, and this often necessitates putting down the briefcase or shopping bag.

### GENESIS OF THE INVENTION

The Genesis of the present invention is a desire to provide a method and apparatus whereby earplugs or earphones can be removed, and inserted, using only a single hand.

### SUMMARY OF THE INVENTION

In accordance for the first aspect of the present invention there is disclosed an acoustic device comprising an integrally formed headset support of generally U-shaped configuration having a bight positioned between a pair of arms, the free end of each arm being dimensioned to be received in the ear shell of a user, and wherein said support includes at least one integrally formed protrusion(s), said support and protrusion being manipulatable by a single hand of a user to expand the distance between said free ends, whereby said free ends can be received into, and removed from, said ear shells utilizing only said single hand.

In accordance with a second aspect of the present invention there is disclosed a method of single handedly removing a headset from the ears, or inserting a headset into the ears, said method comprising the steps of:

(i) providing a headset support of generally U-shaped configuration having a bight positioned between a pair of arms, the free end of each arm being dimensioned to be received in the ear shell of a user,

(ii) providing at least one protrusion,

(iii) manipulating said support and protrusion(s) by grasping same with a single hand to expand the distance between said free ends, and

(iv) removing or inserting said fee ends.

### BRIEF DESCRIPTION OF THE DRAWINGS

Four embodiments of the present invention will now be described with reference to the drawings in which:

FIG. 1 is a perspective view of a headset of the first embodiment,

FIG. 2 is a perspective view of a portion of the headset of FIG. 1 showing a detachable earplug,

FIG. 3 is a front elevation showing the expanding movement of the headset of FIG. 1,

FIG. 4 is a perspective view similar to FIG. 1 but illustrating a headset of the second embodiment,

FIG. 5 is a view similar to FIG. 3 but of the headset of the second embodiment,

FIG. 6 is a view similar to FIG. 1 but of a headset of a third embodiment,

FIG. 7 is a front elevation of the headset of the third embodiment, and

FIG. 8 is a front elevation of a headset of a fourth embodiment.

### DETAILED DESCRIPTION

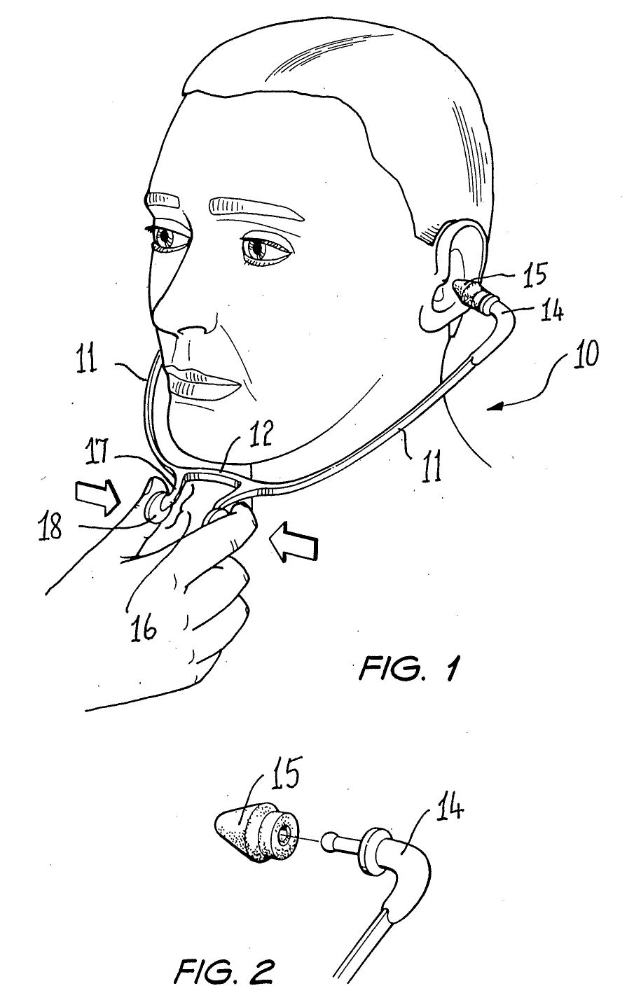

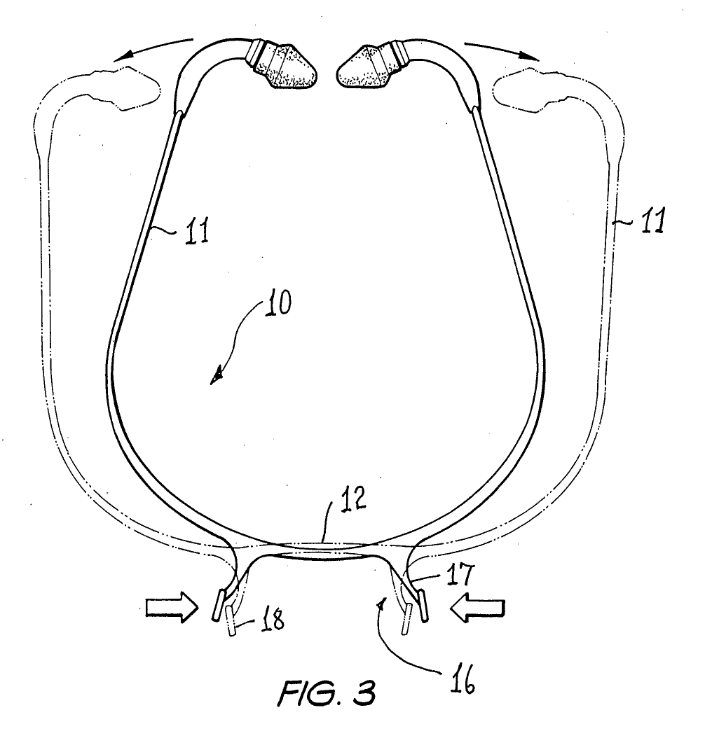

As seen FIGS. 1-3, the acoustic device of the first embodiment is a headset 10 having a pair of arms 11 located one to either side of a bight 12. As best seen in FIG. 2, at the free end 14 of each arm 11 is detachably mounted an ear plug 15. A pair of protrusions 16 is located one to either side of the bight 12. The protrusions 16 extend forwardly away from the face of the user. Each protrusion 16 takes the form of a finger 17 and lug 18. The protrusions 16 and arms 11 are substantially co-planar and are integrally formed by moulding from plastics material such as polypropylene, polycarbonate, or the like.

Because the bight 12 is resilient, the lugs 18 can be grasped by a single hand of the user and compressed, thereby expanding the free ends 14. As a consequence, the earplugs 15 can be removed from the ears of the user by means of a single-handed operation.

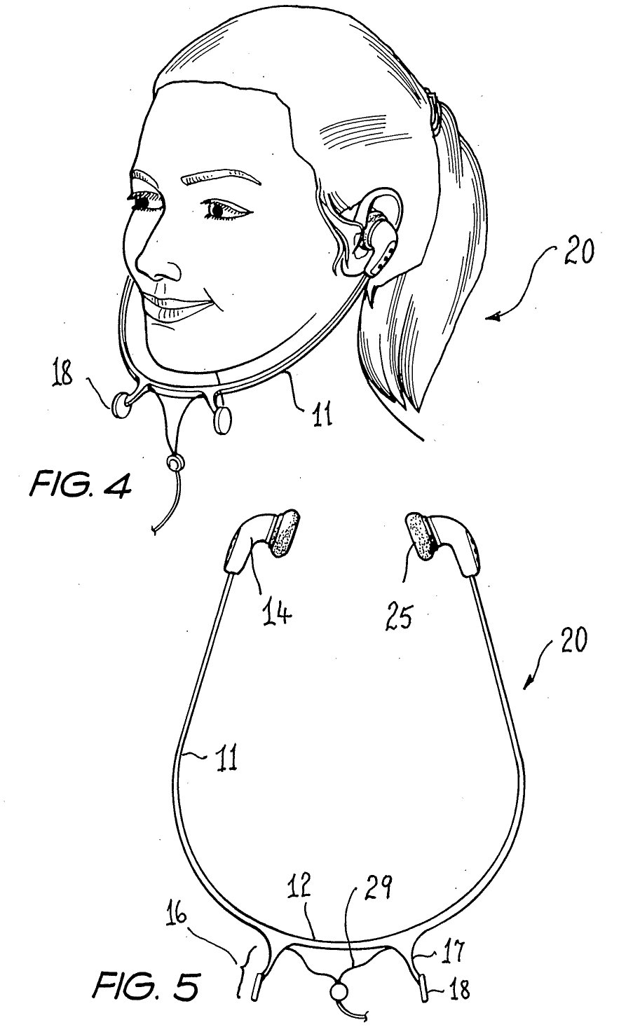

In a second embodiment illustrated in FIGS. 4 and 5, a headset 20 is provided with earphones 25 which are connected to wires 29. In all other respects the headset 20 is identical to the headset 10.

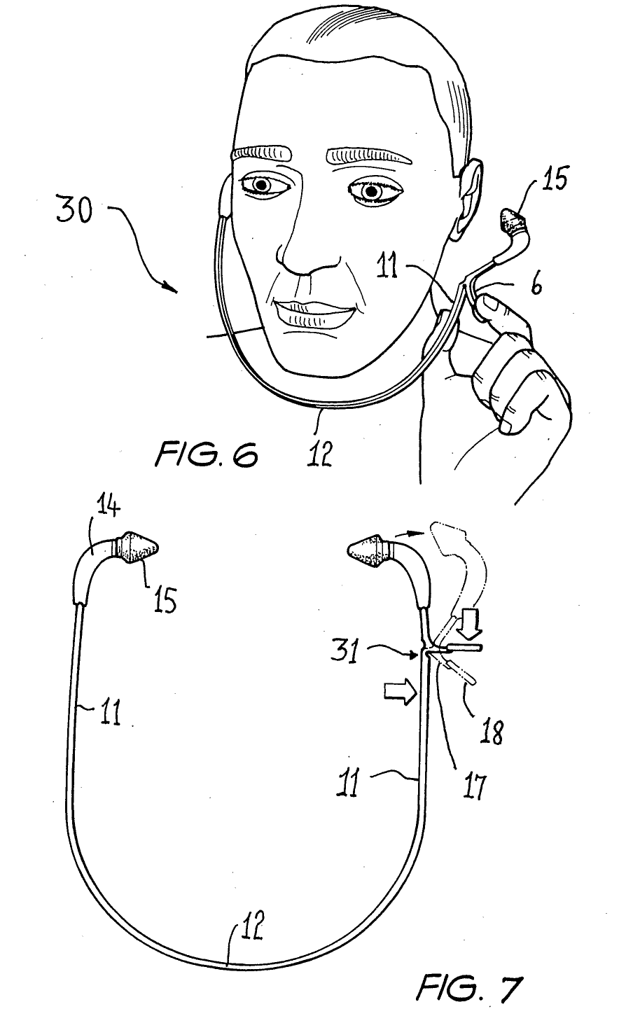

Turning now to FIGS. 6 and 7, a headset 30 of a third embodiment is provided with a single protrusion 36 which again takes the form of a finger 17 and lug 18. Adjacent the protrusion 36, the arm 11 is thinned at 31 so as to form a hinge or pivot. As illustrated in FIG. 6, the user can utilise a single hand to grasp the arm 11 and protrusion 36 and thereby pivot the hinge so as to expand the distance between the earplugs 15. As a consequence, again the headset 30 can be removed from the ears using a single-handed operation.

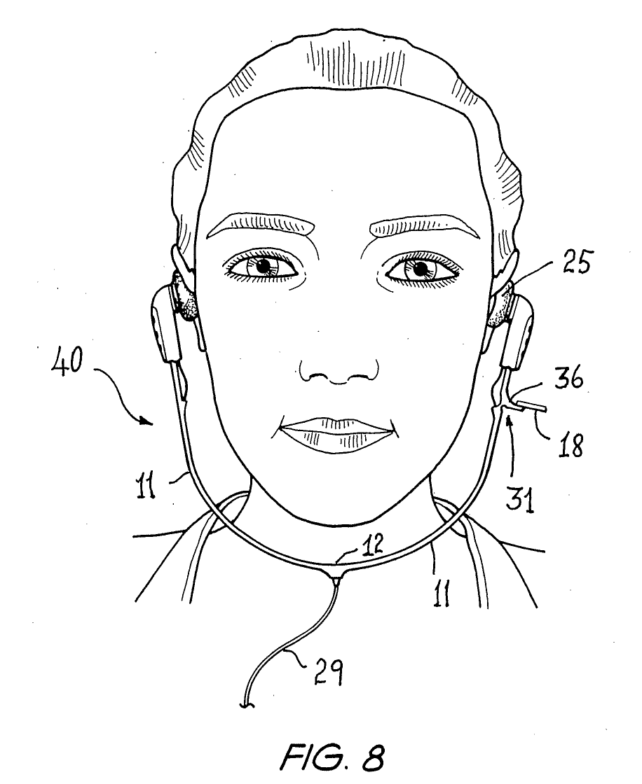

Finally, in FIG. 8, a fourth embodiment of a headset 40 incorporating earphones 25 but otherwise the same as the headset 30, is illustrated. Again, single-handed removal of the earphones 25 from the ears of the user is able to be easily achieved.

The foregoing describes only four embodiments of the present invention and modifications, obvious to those skilled in the acoustic arts, can be made thereto without departing from the scope of the present invention. For example, the wires 29 can be connected to a mobile telephone, or another electric signal generating device such as a WALKMAN or iPOD. Alternatively, a wireless connection to the audio source can be made using BLUETOOTH and similar interconnection mechanisms.

The term “comprising” (and its grammatical variations) as used herein is used in the inclusive sense of “including” or “having” and not in the exclusive sense of “consisting only of”.

1. An acoustic device comprising an integrally formed headset support of generally U-shaped configuration having a bight positioned between a pair of arms, the free end of each arm being dimensioned to be received in the ear shell of a user, and wherein said support includes at least one integrally formed protrusion, said support and protrusion(s) being manipulatable by a single hand of a user to expand the distance between said free ends, whereby said free ends can be received into, and removed from, said ear shells utilizing only said single hand.

2. The device as claimed in claim 1 and comprising a pair of protrusions positioned one to either side of said bight and positioned apart a distance able to be spanned by said single hand.

3. The device as claimed in claim 2 wherein each of said protrusions comprises a finger extending from said support and having a lug at the free end thereof.

4. The device as claimed in claim 3 wherein said fingers and said arms are substantially co-planar.

5. The device as claimed in claim 1 wherein said protrusion is located adjacent the free end of one said arm and the distance between said protrusion and said one arm is able to be spanned by said single hand.

6. The device as claimed in claim 5 wherein a hinge means is positioned between said protrusion and said one arm, said hinge means pivoting to expand the distance between said free ends.

7. The device as claimed in claim 1 wherein each said free end carries an ear plug.

8. The device as claimed in claim 7 wherein said ear plugs are releasably detachable from said free ends.

9. The device as claimed in claim 1 wherein each said free end carries an ear phone.

10. A method of single handedly removing a headset from the ears, or inserting a headset into the ears, said method comprising the steps of:
(i) providing a headset support of generally U-shaped configuration having a bight positioned between a pair of arms, the free end of each arm being dimensioned to be received in the ear shell of a user,
(ii) providing at least one protrusion,
(iii) manipulating said support and protrusion(s) by grasping same with a single hand to expand the distance between said free ends, and with a single hand to expand the distance between said free ends, and
(iv) removing or inserting said free ends.

11. The method as claimed in claim 10 including the further steps of:
(v) providing a pair of said protrusions, and
(vi) locating said pair of protrusions one to either side of said bight and positioned apart by a distance able to be spanned by said one hand.

12. The method as claimed in claim 11 including the further step of:
(vii) forming each said protrusion as a finger extending from said support and having a lug at the free end thereof.

13. The method as claimed in claim 12 including the further step of:
(viii) forming said fingers and arms to be substantially co-planar.

14. The method as claimed in claim 10 including the further step of:
(ix) locating a single protrusion adjacent the free end of one said arm whereby the distance between said protrusion and said one arm is able to be spanned by said single hand.

15. The method as claimed in claim 14 including the further steps of:
(x) positioning a hinge means between said protrusion and said one arm, and
(xi) pivoting said hinge means to expand the distance between said free ends.
